(19) United States
(12) Patent Application Publication
(10) Pub. No.: US 2025/0029516 A1
(43) Pub. Date: Jan. 23, 2025

(54) INTERACTIVE RIP CURRENT SIMULATOR

(71) Applicant: Jeff Wheat, Navarre, FL (US)

(72) Inventor: Jeff Wheat, Navarre, FL (US)

(21) Appl. No.: 18/735,366

(22) Filed: Jun. 6, 2024

Related U.S. Application Data
(60) Provisional application No. 63/527,617, filed on Jul. 19, 2023.

(51) Int. Cl. G09B 23/12

(52) U.S. Cl. CPC G09B 23/12

(57) ABSTRACT

A simulator apparatus has a vessel configured to provide a predefined fluid level and having a contoured bottom surface between a beach end wall and an opposing deep end wall, and between first and second side walls. The bottom surface defines a shoreline boundary at the fluid level between the first and second side walls, a beach shoreline region above the fluid level, an underwater region, extending from the shoreline boundary toward the deep end wall, with a shallow bleach floor region. First and second ridged features define corresponding shoal regions between the ridged features and the shoreline boundary. A gap between the first and second ridged features, provides a back channel that redirects fluid toward the deep end wall. One or more fluid outlets direct fluid toward the first and second ridged features of the bottom surface, forming a simulated rip current.

### CROSS REFERENCE TO RELATED APPLICATIONS

Reference is made to, and priority is claimed from, commonly assigned U.S. Ser. No. 63/527,617 filed as a provisional patent application on 19 Jul. 2023, entitled “INTERACTIVE RIP CURRENT SIMULATOR” in the name of Jeff Wheat, incorporated herein in its entirety.

### TECHNICAL FIELD

The present disclosure generally relates to instructional simulators for demonstrating the reaction of a fluid material to applied physical force and for interactive teaching about the dynamics that cause a rip current and about how to respond more safely.

### BACKGROUND

Lifeguards along U.S. coastal beaches and the parts of the Great Lakes shoreline rescue tens of thousands of people annually from rip currents. Each year, however, it is estimated that 100 or more people are killed as a result of rip current activity. Rip currents are localized narrow channels of fast-moving water that can be quite powerful, moving away from the shoreline at speeds of up to 8 ft. per second, faster than racing speeds achieved by Olympic swimmers. Upon encountering a rip current, swimmers characteristically tend to panic, attempting feverishly to swim directly back towards shore. The best solution, however, which is somewhat non-intuitive to the alarmed swimmer who suddenly experiences the force of the rip current flow, is not to swim directly against the current but rather to move parallel to the shore for a short distance before heading in. Among other benefits, this strategy helps to reduce swimmer panic, so that the swimmer can work away from the narrow rip channel first, then proceed back toward land in a more angular fashion.

Well aware of the typical conditions that precipitate a rip current and of the risks these pose to an uninstructed population, beach safety authorities spend considerable sums on warning signage, audible alarm systems, posters, pamphlets, flags, and other mechanisms to help warn and instruct beach-goers. However, the various distractions of beach activity tend to drown out these well-intentioned attempts to provide useful warning and instructional information. As a result, safety and rescue personnel must often address this additional problem in an emergency mode, working hard to prevent catastrophic results that can occur under rip current conditions.

Thus, it can be appreciated that conventional solutions have been relatively ineffective in addressing the problems of teaching the public about rip current effects and eliciting the proper behavioral response under rip current conditions.

### SUMMARY

It is an object of the present disclosure to advance the art of instruction for rip current detection and response for the general public.

Embodiments of the present disclosure provide a simulator apparatus comprising:
an open-topped vessel configured to provide a fluid reservoir with a predefined fluid level, the vessel having a contoured bottom surface extending in a length direction between a beach end wall of the vessel and a deep end wall of the vessel opposite the beach end wall, and in a width direction between first and second side walls that extend between the beach end and deep end walls,
wherein the bottom surface defines:
   (a) a shoreline boundary that extends at the fluid level between the first and second side walls of the vessel;
   (b) a beach shoreline region, above the fluid level and extending from the shoreline boundary toward the beach end wall of the vessel;
   (c) an underwater region, below the fluid level and extending from the shoreline boundary toward the deep end wall, and that comprises a shallow bleach floor region that slopes away from the shoreline boundary,
wherein first and second ridged features define corresponding first and second shoal regions within the beach floor region, between the ridged features and the shoreline boundary,
wherein a gap, formed between the first and second ridged features, is configured to provide a back channel that redirects fluid that collects within the beach floor region toward the deep end wall;
and
one or more fluid outlets configured to direct a stream of fluid toward the first and second ridged features of the bottom surface, forming a simulated rip current through the back channel.

These objects are given only by way of illustrative example, and such objects may be exemplary of one or more embodiments of the disclosure. Other desirable objectives and advantages inherently achieved by the disclosure may occur or become apparent to those skilled in the art. The invention is defined by appended claims.

### BRIEF DESCRIPTION OF THE DRAWINGS

The foregoing and other objects, features, and advantages of the disclosure will be apparent from the following more particular description of the embodiments of the disclosure, as illustrated in the accompanying drawings. The elements of the drawings are not necessarily to scale relative to each other.

FIG. 1A is a perspective view that shows how rip current can be generated from incoming currents.

FIG. 1B is a top view that shows rip current formation from current vectors.

FIG. 2 is a perspective view showing participant interaction with the rip current simulator in a typical site setup.

FIG. 3A is a side perspective view showing the rip current simulator according to an embodiment of the present disclosure.

FIG. 3B is a perspective view showing the simulator in an alternative embodiment, with a fluid inlet and drainage outlet.

FIGS. 4A and 4B are perspective views showing the bottom surface of the rip current simulator according to an embodiment of the present disclosure.

FIG. 5 is a perspective view showing features of the bottom surface.

FIG. 6 is a top view topographical contour presentation of the graduated surface contour along the bottom surface of the rip current simulator vessel according to an embodiment of the present disclosure.

FIGS. 7A and 7B are perspective views of the bottom surface showing typical ridge features, gap, and shoal regions as viewed from different angles.

FIG. 8 is a front perspective view showing the optional control housing for pump actuation and control according to an embodiment of the present disclosure.

### DETAILED DESCRIPTION

Figures provided herein are given in order to illustrate principles of operation and component relationships according to the present disclosure and are not drawn with intent to show actual size or scale. Some exaggeration may be necessary in order to emphasize basic structural relationships or principles of operation. Some conventional components that would be needed for implementation of the described embodiments, such as support components used for providing power, for packaging, and for mounting, for example, are not shown in the drawings in order to simplify description. In the drawings and text that follow, like components are designated with like reference numerals, and similar descriptions concerning components and arrangement or interaction of components already described may be omitted.

Where they are used, the terms “first”, “second”, and so on, do not necessarily denote any ordinal or priority relation, but may be used for more clearly distinguishing one element or time interval from another. The term “plurality” means at least two.

In the context of the present disclosure, the term “energizable” describes a component or device that is enabled to perform a function upon receiving power and, optionally, upon also receiving an enabling signal.

In the context of the present disclosure, positional terms such as “top” and “bottom”, “upward” and “downward”, and similar expressions are used descriptively, to differentiate different surfaces or views of the simulator assembly with its standard orientation.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

The term “exemplary” is used herein to mean “serving as an example, instance, or illustration.” Any aspect described herein as “exemplary” is not necessarily to be construed as preferred or advantageous over other aspects. The term “fluid” as used herein describes water or other liquid used to simulate water flow.

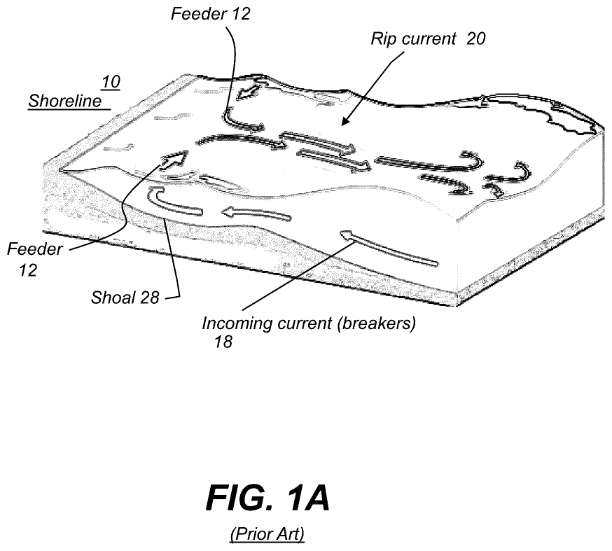

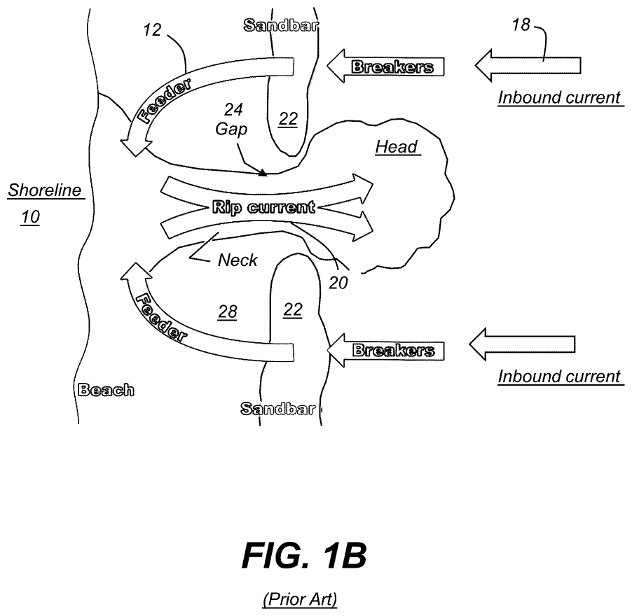

The perspective diagram of FIG. 1A and top view of FIG. 1B show how a rip current is formed and helps to describe terminology that is used for typical currents and conditions related to rip current behavior. Incoming breakers have an incoming drive current 18 causing movement that impels the surface water toward a beach or shoreline 10. Under some conditions, water returned from impact along shoreline 10 dissipates its energy in a random, un-localized fashion, so that there can be a temporary, periodic backwards current following the arrival of each wave all along the shoreline, but without combination of the backwards forces.

A rip current 20 occurs when the incoming current flow cooperates with underlying surface conditions along shoal areas 28 near beach 10 to redirect two or more feeder currents 12 together for interaction with each other. The currents, repulsed along the shoreline, come into contact with each other and combine their energies to yield a backward current force acting in a highly localized manner between them. The resulting rip current 20 can exert considerable force that tends to impel any floating object in a generally orthogonal direction, away from the shoreline.

The top view of FIG. 1B shows a typical rip current pattern as a series of force vectors, and shows underlying surface features that can contribute to rip current formation. Along the surface contour, a pair of sandbars 22 form shoals 28 that can provide shallower, ridged regions of the ocean floor, separated by a gap 24, having neck and head portions with the typical layout pattern shown. The rip current 20 is formed from fluid that has collected in shoals 28 from the feeder currents 12; the collected fluid combines to flow through the gap 24, outwards from shoreline 10, in a direction substantially orthogonal to shoreline 10.

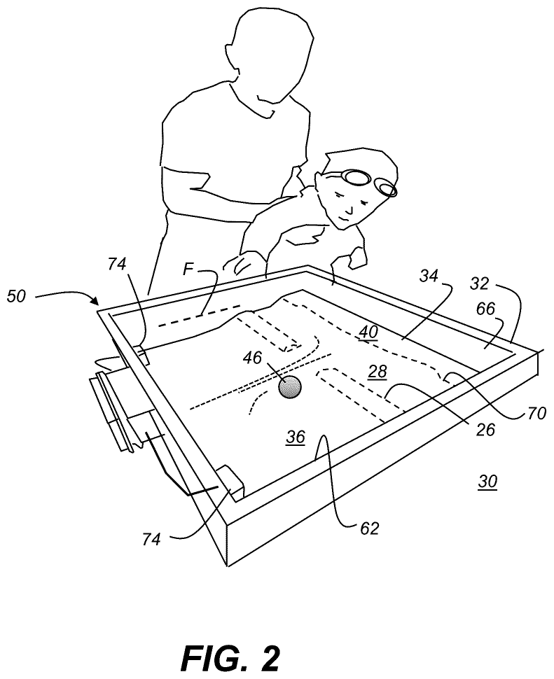

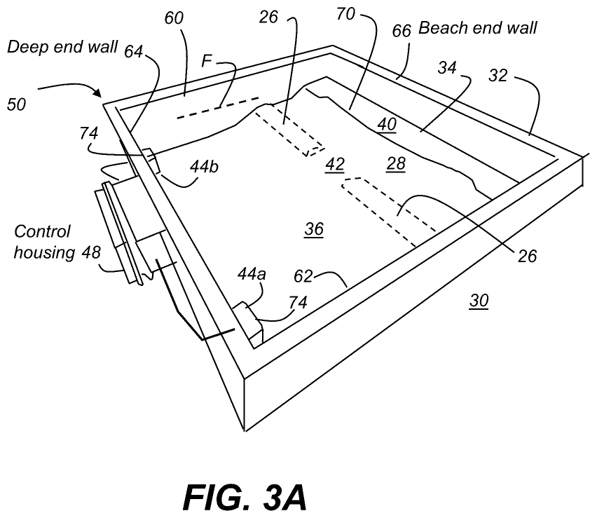

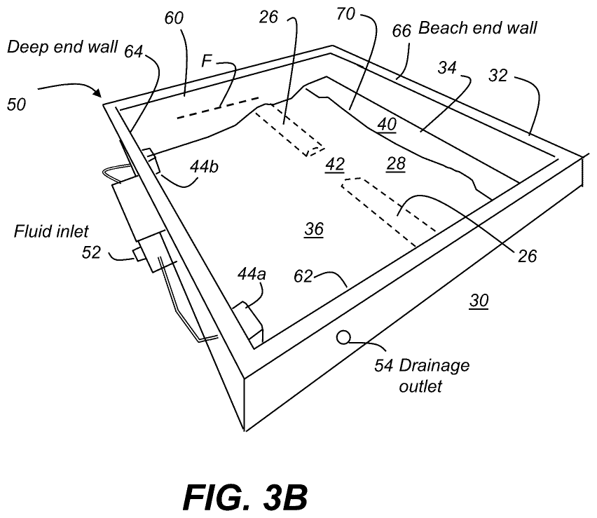

FIGS. 2 and 3A are front perspective views of a portion of a rip current simulation apparatus 30 that uses an open vessel 32 having a deep end wall 64 and a beach end wall 66 and side walls 60, 62 extended therebetween. Vessel 32 has a predefined fluid level F, wherein apparatus 30 is configured to generate a rip current at a small scale. According to an embodiment of the present disclosure, vessel 32 has a bottom surface 34 that defines beach and underwater regions on opposite sides of a shoreline boundary 70. At a first, deep end 50, a deeper region 36 serves as a reservoir for the bulk the fluid. Bottom surface 34 is contoured to emulate an ocean floor surface inclining toward a shoreline boundary 70 and having a beach region 40, that is raised just above the fluid level F and extends between side walls 60 and 62, toward beach end wall 66. Because simulator 30 can be formed as a portable device in some embodiments, it can be readily transported from place to place, particularly suitable for instructing children as well as adult swimmers and for the instruction of the beach-going public in general.

Considered moving toward deep end wall 64, the contour of the bottom surface slopes generally downward from shoreline boundary 70 to provide first and second shoal regions 28 defined by ridged features 26, emulating the sandbars 22 shown in FIG. 1B, wherein each shoal region 28 is bounded between a ridged feature 26 and the shoreline boundary 70. The bottom contour further provides a gap 42 formed between the first and second ridged features 26. A first fluid outlet 44a and a second fluid outlet 44b, both at least partially submerged along deep end wall 64 in the deeper region 36, act as jets that direct a stream of fluid, typically flowing through nozzles that increase the fluid pressure and control fluid direction from the outlet ports, and impel the fluid toward the first and second ridged features 26.

In the embodiment shown in FIGS. 2 and 3A, a control housing 48 can provide DC current to an optional pump or pumps 74 that can be energized to act as a fluid source for forcing water or other suitable fluid under pressure through nozzles or outlets 44a, 44b and can optionally allow manual adjustment of fluid flow speed. Pumps 74 can be submerged pumps, for example. Alternately, a single pump 74, submerged or even external to vessel 32, can be provided to support one, two, or more outlets 44a and 44b, as needed.

Fluid level F can be indicated on walls of the vessel. These markings can also be used as a guide for filling vessel 32 and for maintaining the simulator 30 in a level position.

According to an alternate embodiment of the present disclosure, shown in FIG. 3B, no pump 74 is needed in order to provide fluid under pressure through outlets 44a, 44b. FIG. 3B is a perspective view showing simulator 30 in this alternative embodiment, with a fluid inlet 52 for providing water to outlets 44a, 44b from an external source with water pressure and a drainage outlet 54 for maintaining fluid level F. When appropriate drainage is available, and a water source with sufficient pipeline pressure is provided, simulator 30 can thus be operated without electric energy. To maintain the fluid level F, the needed stream or streams of fluid can be provided in a simple manner, connected, through inlet 52 provided along the deep end wall 64 or side wall, to an external water supply faucet using flexible tubing, piping, or standard garden hose or other suitable conduit for fluid communication with an external source. The use of a conventional faucet or garden hose connector, providing sufficient current flow at suitable pressures through nozzles or other devices, can allow further portability of the simulator device, with excess water draining from vessel 32 and flowing into a bucket, pool, garden, or other area. Drainage outlets 54 can be provided, such as in either or both of the side walls 60,62 in order to maintain the correct fluid level. A floating object 46 can act as a movable marker for indicating fluid flow as the object 46 is moved along the surface of the fluid in vessel 32. Other types of indicator for rip flow generation can also be employed, including submerged objects that respond to fluid movement.

Submerged nozzles used for fluid outlets 44a and 44b can be adjustable to increase or decrease flow pressure as needed. Nozzle angle adjustment by the user can also be provided.

Outlets 44a, 44b can alternately be provided with directional output for steering the discharged fluid current toward ridged features 26 over a range of angles. The ability to adjust the flow volume, current speed, and angle can help to demonstrate ideal conditions under which rip current can be maximized within simulator 30. Adjustment can also be used to show how rip current can develop quickly with slight changes in external conditions.

Various mechanisms can be employed for adjusting the velocity and angle of flow from outlets 44a, 44b, for adjusting the relative spread of the fluid stream outflow, and the angular direction of the fluid flow. Pumps 74 can be mounted in housings that are held magnetically against the inner walls of vessel 32; other mechanical means for pump 74 mounting and/or outlet 44a, 44b positioning can be employed, using techniques well known in the art. A housing (not shown) can be provided for pump 74, wherein the housing provides an intake conduit and the flow discharge outlet.

Pumps 74 can be DC pumps, powered by battery or from sources that draw DC energy from the AC line, but that isolate the device from current levels that might present electrical risk. The power supply can be a conventional “wall-wart” power converter, such as that used for numerous electronic devices, for example. Rechargeable batteries can alternately be used. Batteries can be mounted, for example, in or against control housing 48 (FIG. 3). A low battery state can be signalled using an appropriate LED indicator or by energizing an apparatus that provides an audible signal, for example.

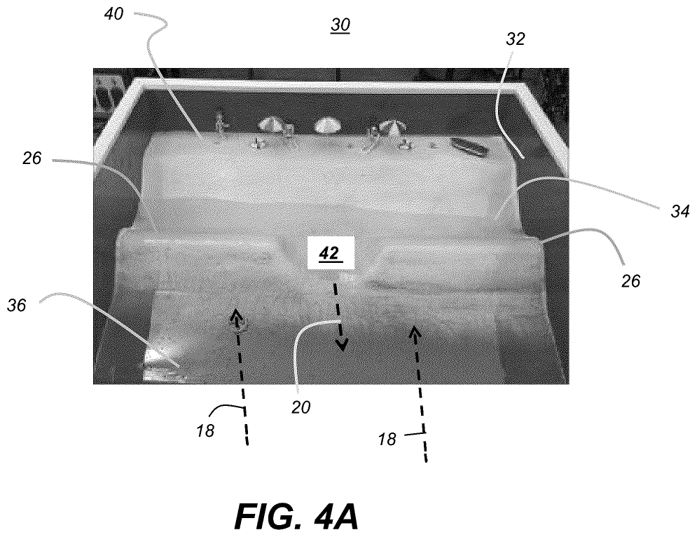

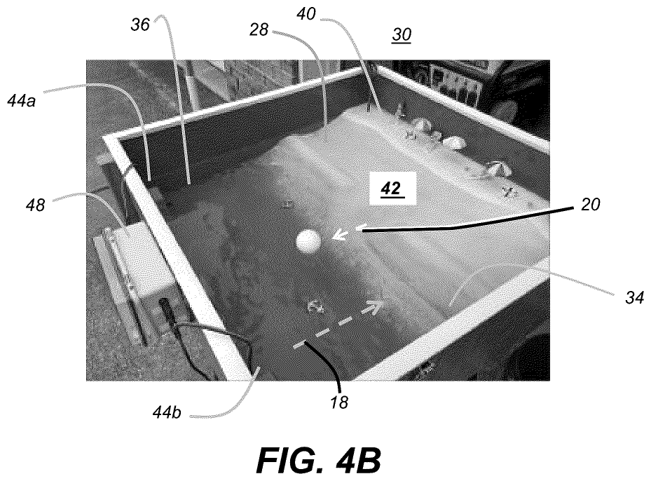

FIGS. 4A and 4B show, in perspective views, various features of vessel 32 for simulator 30, shown without fluid for improved visibility of bottom surface 34 components. Beach 40, configured on bottom surface 34 to lie above fluid level F, can be populated with miniature figures and beach paraphernalia as shown. FIG. 4A in particular shows the relative location and prominence of ridge features 26.

FIG. 4B is a side perspective view showing the rip current simulator 30 annotated to show directions for incoming breaker flow current 18 from fluid outlet 44b and the resulting rip current 20 according to an embodiment of the present disclosure.

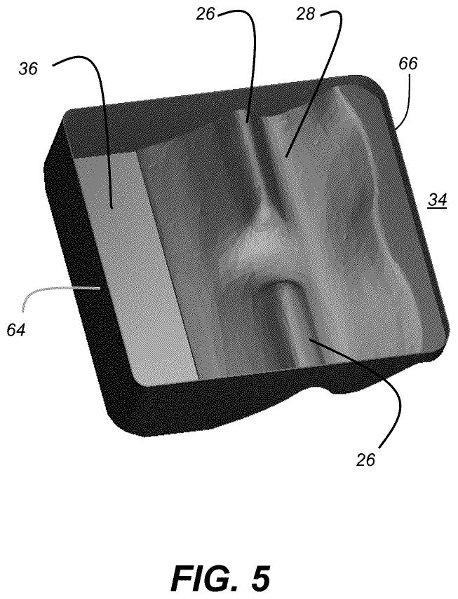

FIG. 5 is a perspective view that shows features of bottom surface 34 according to an embodiment of the present disclosure, particularly showing the sloped pattern of surface 34 as interrupted by surface features 26 to form shoals 28 in the beach floor region. Some tolerance can be allowed for variability in fluid levels, nozzle pressure, and other parameters.

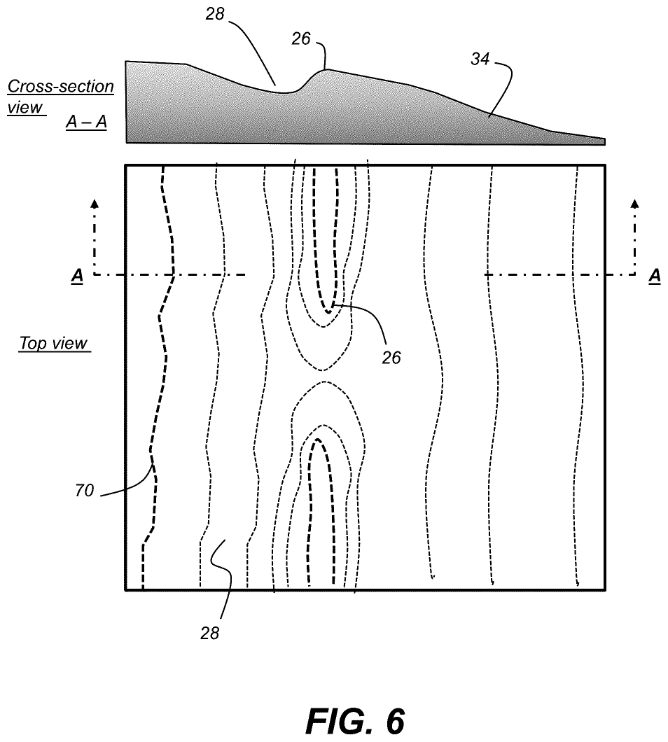

FIG. 6 is a top view topographical contour presentation of the graduated surface contour of the rip current simulator vessel according to an embodiment of the present disclosure. A cross-section view of the surface contour along a reference line A-A is also shown along the top of FIG. 6, with approximate positions of ridged features 26 and of shoal 28 indicated. From the top view, shoreline boundary 70 can appear as an irregular or meandering line that stretches across bottom surface 34. In practice, the precise location of shoreline boundary 70 can be defined by the amount of fluid contained and by factors such as leveling of vessel 32, as installed at a site; thus shoreline boundary 70 need not be rigidly fixed, but can vary over a range of positions.

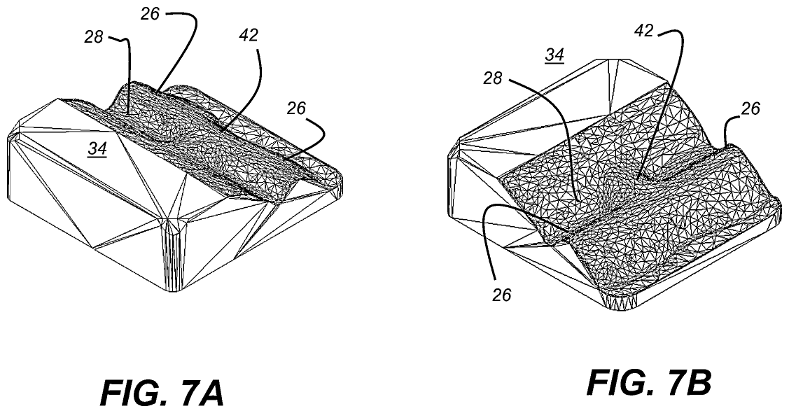

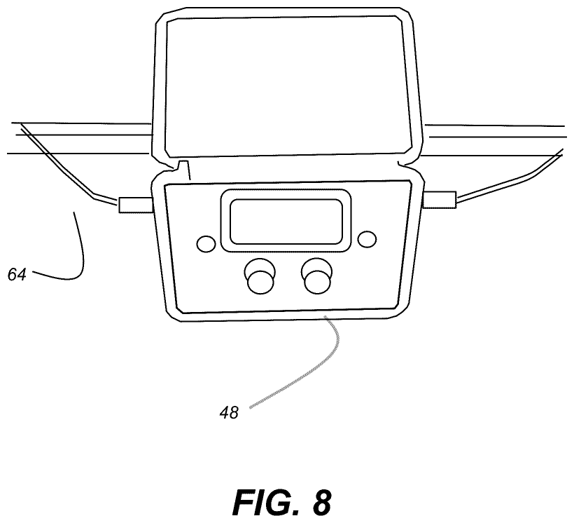

FIGS. 7A and 7B are perspective views of bottom surface 34 in point/mesh representation, particularly showing ridge features 26, gap 42, and shoal 28.

FIG. 8 is a front perspective view showing optional control housing 48 which can be mounted along or against deep end wall 64 according to an embodiment of the present disclosure. Controls for pump speed and/or volume, as well as for nozzle direction at the fluid outlets, can be provided in order to facilitate use for presentation and training.

Embodiments of the present disclosure show simulator 30 as a table-top apparatus, designed for portability and readily setup and disassembled for travel. Larger versions of the device, using the contoured bottom surface 34 as described, can be fabricated, including apparatus of sufficient size for holding one or more swimmers, for example. According to an embodiment of the present disclosure, simulator 30 can be formed within a vessel of 24″w×24″L×8″H plywood box that is painted or otherwise treated for water resistance. The inside surface can have an epoxy-resin coating; the outer surfaces can be stained and treated with polyurethane or other water repellent coating. At this size, the simulator needs only about 5 gallons of water for operation. When empty, the box formed in this manner can weigh about 22 pounds; when loaded with water, the weight can be above 60 pounds. Simulator 30 of such design can be readily suitable for operation on a table top or at ground level, as needed in a particular environment. An optional top or cover (not shown) can be affixed or hinged to vessel 32 for packing and travel; one or both sides of the cover can serve as a chalkboard or white-board for instructor use.

Vessel 32 can alternately be formed using other materials, such as a molding from a thermo-formed plastic, reinforced and fabricated for sufficient resilience and durability. Various types of metal framing and reinforcement can be used for setup and support, with suitable openings for pipe couplings and drainage, for example, allowing straightforward packing, transfer, setup, and tear-down.

Surface features within the vessel can be molded or formed of foam that can be worked by hand to provide the needed patterning. A variety of paint and resins can be applied for protection from water and from contact. According to an embodiment of the present disclosure, the vessel surface is molded, such as using a thermoplastic material, to provide a suitable surface contour, as shown in the perspective view example of FIG. 5. The molded surface can be formed as the bottom of the vessel 32 or can be sealed against the bottom of vessel 32. According to an alternate embodiment of the present disclosure, the viewer can manually adjust portions of the bottom surface contour to vary rip current conditions.

A level supporting surface of some type is needed for vessel 32 so that the water stored and routed within vessel 32 exhibits the needed flow patterns. For a portable version, a table top or temporary platform, such as portable sawhorses, can be used for support of simulator 30.

Embodiments shown herein can use a ping-pong ball (or larger table tennis ball) as a convenient vehicle for demonstrating rip current behavior. More elaborate and detailed devices could serve as objects 46, particularly items that are at least substantially buoyant and that are able to be moved by the current flow from nozzles or outlets 44a, 44b. It should be noted that a pump arrangement can alternately include a single pump; a single pump with two outlets 44a,44b, or any number of pumps providing outlets with various flow patterns that would allow teaching as well as study. While a table-top version for simulator 30 is shown, it can be appreciated that the apparatus can be formed at larger scale, even forming a rip current simulator with proper surface contour that is swimming pool-sized and allows demonstration to, and use by, swimmers, such as for training rescue personnel, for example.

According to an alternate embodiment of the present disclosure, simulator 30 includes an audible beeper or a speaker that emulates a siren or other suitable sound when rip current conditions are provided. Visual indicators, such as lights indicating “All Clear” or “Rip Current Warning” conditions can be provided on simulator 30. Indicator lights can also be provided within the vessel 32 to show that pumps are operating or to show current flow direction, for example. Various sensors can be used to detect and report current flow conditions, for example.

Vessel 32 can be designed for clear water. However, various particulates, colorants or pigments can be added to the fluid, such as for instructional purposes. Vessel 32 can have overflow ports that provide drainage to help maintain the proper fluid levels for successful rip current simulation.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A simulator apparatus comprising:
an open-topped vessel configured to provide a fluid reservoir with a predefined fluid level, the vessel having a contoured bottom surface featured to emulate a sloped beach floor extending between a beach end wall of the vessel and a deep end wall of the vessel opposite the beach end wall, and between first and second side walls that extend between the beach end and deep end walls,
wherein the bottom surface defines:
(a) a shoreline boundary that extends at the fluid level between the first and second side walls of the vessel;
(b) a beach shoreline region, above the fluid level and extending from the shoreline boundary toward the beach end wall of the vessel;
(c) an underwater region, below the fluid level and extending from the shoreline boundary toward the deep end wall, and that comprises a shallow bleach floor region that slopes away from the shoreline boundary,
wherein first and second ridged features define corresponding first and second shoal regions within the beach floor region, between the ridged features and the shoreline boundary,
wherein a gap, formed between the first and second ridged features, is configured to provide a back channel that redirects fluid that collects within the beach floor region toward the deep end wall;
and
one or more fluid outlets configured to direct a stream of fluid within the vessel toward the first and second ridged features of the bottom surface, forming a simulated rip current through the back channel.

2. The apparatus of claim 1 comprising at least a first pump that is in fluid communication with at least one or more fluid outlets.

3. The apparatus of claim 2 wherein the at least the first pump has a variable flow rate adjustable by a user.

4. The apparatus of claim 1 wherein the at least the first pump has a variable flow angle adjustable by a user.

5. The apparatus of claim 1 wherein fluid depth within the gap exceeds fluid depth within the shoal regions.

6. The apparatus of claim 1 further comprising an indicator that is configured to signal a generated rip current condition within the vessel.

7. The apparatus of claim 1 wherein the fluid is provided from an external water source.

8. The apparatus of claim 7 further comprising at least one drainage hole that allows fluid flow through at least one of the first or second side walls.

9. The apparatus of claim 1 further comprising an audible signal generator that is energizable to indicate rip current conditions.

10. The apparatus of claim 1 wherein the bottom surface of the vessel is formed from a molded thermoplastic.

11. A simulator apparatus comprising:
an open-topped vessel configured for containing a predetermined amount of fluid at a fluid level,
the vessel having a sloped bottom surface that is contoured to emulate a portion of an ocean floor surface, extending from a deeper region of the vessel that lies below the fluid level, to a shallower shoal region, and further extending to an emulated beach shoreline and to a beach region that lies above the fluid level and extends along an opposite, rear end of the vessel,
wherein the contour of the bottom surface slopes upward from the deeper region toward the fluid level and continues above fluid level to the beach region;
wherein the shoal region is defined between at least first and second ridged features of the bottom surface and the beach shoreline, and wherein a gap formed between the at least first and second ridged features is configured to redirect fluid that collects within the shoal region away from the beach shoreline; and
at least a first pump and a second pump, wherein the at least first and second pumps are each least partially submerged and are energizable to direct a fluid current inside the vessel toward the first and second ridged features.

12. The apparatus of claim 11 wherein fluid depth within the gap exceeds fluid depth within the shoals.

13. The apparatus of claim 11 wherein the at least the first pump has a variable flow rate that is adjustable by a user.

14. The apparatus of claim 11 wherein the at least the first pump has a variable flow angle that is adjustable by a user.

15. The apparatus of claim 11 further comprising an indicator that is configured to signal a detected rip current condition within the vessel.

16. The apparatus of claim 11 further comprising a hinged lid for the vessel, wherein the hinged lid includes a surface for writing.

17. A simulator apparatus comprising:
an open-topped vessel configured for containing a predetermined amount of fluid at a fluid level,
the vessel having a sloped bottom surface that is contoured to emulate a portion of an ocean floor surface, extending from a deeper region of the vessel that lies below the fluid level, to a shallower shoal region, and further extending to an emulated beach shoreline and to a beach region that lies above the fluid level and extends along an opposite, rear end of the vessel,
wherein the contour of the bottom surface slopes upward from the deeper region toward the fluid level and continues above fluid level to the beach region;
wherein the shoal region is defined between at least first and second ridged features of the bottom surface and the beach shoreline, and wherein a gap formed between the at least first and second ridged features is configured to redirect fluid that collects within the shoal region away from the beach shoreline;
and
a fluid inlet for connection to an external source of water having sufficient pressure to impel the fluid inside the vessel toward the first and second ridged features.

18. The apparatus of claim 17 wherein the fluid inlet is in fluid communication with one or more nozzles in the deeper region of the vessel.

19. The apparatus of claim 17 wherein the vessel further comprises at least one drainage hole that maintains the fluid within the vessel at the fluid level.
